(19) United States
(12) Patent Application Publication
(10) Pub. No.: US 2018/0204276 A1
(43) Pub. Date: Jul. 19, 2018

(54) BRAIN ACTUATED CONTROL OF AN E-COMMERCE APPLICATION

(71) Applicant: David M. Tumey, Coral Springs, FL (US)

(72) Inventor: David M. Tumey, Coral Springs, FL (US)

(21) Appl. No.: 15/867,765

(22) Filed: Jan. 11, 2018

Related U.S. Application Data
(60) Provisional application No. 62/446,884, filed on Jan. 17, 2017.

(51) Int. Cl. G06Q 30/06; G06F 3/01; G06F 3/0481

(52) U.S. Cl. CPC G06Q 30/0643; G06F 3/04815; G06F 3/015

(57) ABSTRACT

A brain-to-computer interface providing brain actuated control of a 3D virtual/augmented/mixed reality e-commerce application is effected by releasably attaching a plurality of high-impedance dry Ag/Ag—Cl electrodes to selected locations on a human user's scalp; providing a low-noise, high-gain, instrumentation amplifier electrically associated with said plurality of electrodes; utilizing a high-resolution Analog-to-Digital (A/D) converter electrically associated with said instrumentation amplifier and said computer to digitize human biopotential signals (EEG, EOG and EMG) detected by said plurality of electrodes; and, analyzing said digitized human biopotential signals utilizing a computer algorithm to provide control inputs to said e-commerce application, including, for example, locomotion within the virtual space, manipulation of objects such as commercial offerings, and completing selection and purchasing functions using a virtual shopping cart.

### FIELD OF THE INVENTION

The present invention relates to a brain-to-computer interface. More particularly, the invention relates to a system for providing brain-actuated control of a virtual/augmented/mixed reality e-commerce application by measuring and analyzing a human user's biopotentials (EEG, EOG, and EMG) and providing a response thereto.

### BACKGROUND OF THE INVENTION

History of e-Commerce

By definition, e-commerce or electronic commerce, is the buying and selling of products or services via the Internet. For many people world-wide, e-commerce is something we participate in on a daily basis; for example, online bill payment or purchasing from an e-tailer, e.g., Amazon.com, eBay.com, and Walmart.com. Today, e-commerce is ubiquitous and the thought of living without it seems unfathomable, complicated and an inconvenience. E-commerce was introduced 40 years ago and, to this day, continues to grow with new technologies, innovations, and thousands of businesses entering the online market each year. The convenience, safety, and user experience of e-commerce has improved exponentially since its inception in the 1970's.

1960-1982

Paving the way for e-commerce was the development of the Electronic Data Interchange (EDI). EDI replaced traditional mailing and faxing of documents with a digital transfer of data from one computer to another. Trading partners could transfer orders, invoices and other business transactions using a data format that met the ANSI ASC X12, the predominant set of standards in North America.

Once an order was sent, it was subsequently examined by a VAN (Value-Added Network) and finally directed to the recipient's order processing system. EDI allowed the transfer of data seamlessly without any human intervention.

Michael Aldrich, an English inventor, innovator and entrepreneur is credited with developing the predecessor to online shopping. The idea came about during a stroll with his wife and Labrador when Aldrich lamented about their weekly supermarket shopping expedition. This conversation sparked an idea to interface a television monitor and a computer to their supermarket to enable ordering and delivery of their groceries. Immediately after the discussion Aldrich quickly planned and implemented his idea.
In 1979 Aldrich connected a television monitor to a transaction processing computer with a telephone line and created what he coined, “teleshopping,” meaning shopping at a distance.
1982-1990

It was apparent from the beginning that Business to Business (B2B) online shopping would be commercially lucrative but Business to Consumer (B2C) would not be successful until the later widespread use of PC's and the birth of the World Wide Web, also known as, the Internet. In 1982, France launched the precursor to the Internet called, Minitel. The online service used a Videotex terminal machine that was accessed through telephone lines. The Minitel was free to telephone subscribers and connected millions of users to a computing network.

By 1999, over 9 million Minitel terminals had been distributed and were connecting approximately 25 million users in this interconnected network of machines. Use of the Minitel system peaked in 1991 and slowly declined after the success of the Internet a few years later. Eventually, in 2011, France Telecom announced its shutdown of the Minitel service system. Sadly, it had not become what it had hoped to be, the Internet.

In the United States, the Advanced Research Projects Agency Network (ARPANET) was an early packet switching network and the first network to implement the protocol suite TCP/IP. Both technologies became the technical foundation of the Internet. ARPANET was initially funded by the Advanced Research Projects Agency (ARPA) of the United States Department of Defense.

The packet switching methodology employed in the ARPANET was based on concepts and designs by Americans Leonard Kleinrock and Paul Baran, British scientist Donald Davies, and Lawrence Roberts of the Lincoln Laboratory. The TCP/IP communications protocols were developed for ARPANET by computer scientists Robert Kahn and Vint Cerf, and incorporated concepts by Louis Pouzin for the French CYCLADES project.

As the project progressed, protocols for the Internet were developed by which multiple separate networks could be joined into a network of networks. Access to the ARPANET was expanded in 1981 when the National Science Foundation (NSF) funded the Computer Science Network (CSNET). In 1982, the Internet protocol suite (TCP/IP) was introduced as the standard networking protocol on the ARPANET. In the early 1980s the NSF funded the establishment for national supercomputing centers at several universities, and provided interconnectivity in 1986 with the NSFNET project, which also created network access to the supercomputer sites in the United States from research and education organizations. ARPANET was decommissioned in 1990.

90's-Present

In 1990 Tim Berners-Lee, along with his friend Robert Cailliau, published a proposal to build a “Hypertext project” called, “World-Wide Web.” The inspiration for this project was modeled after the Dynatex SGML reader licensed by CERN.

That same year, Berners-Lee, using a NeXT computer created the first web server and wrote the first web browser. Shortly thereafter, he went on to debut the web on Aug. 6, 1991 as a publicly available service on the Internet. When Berners-Lee decided he would take on the task of marrying hypertext to the Internet, in doing that, the process led to him developing URL, HTML and HTTP protocols.

When the National Science Foundation lifted its restrictions on commercial use of the NSFNET in 1991, the Internet and online shopping saw remarkable growth. In September 1995, the NSF began charging a fee for registering domain names. 120,000 registered domain names were present at that time and within 3 years that number grew to beyond 2 million. By this time, NSF's role in the Internet came to an end and a lot of the oversight shifted to the commercial sector.

From the beginning, there were many hesitations and concerns with online shopping but the development of a security protocol—the Secure Socket Layers (SSL)—encryption certificate by Netscape in 1994 provided a safe means to transmit data over the Internet. Web browsers were able to check and identify whether a site had an authenticated SSL certificate and based on that, could determine whether or not a site could be trusted.

Now, SSL encryption protocol has been replaced by Transport Layer Security (TLS) and is a vital part of web security. Version 1.2 has become the standard for most web servers today.

### Online E-Commerce Megastores

The mid-nineties to 2000's saw major advancements in the commercial use of the Internet. The largest online retailer in the world, Amazon, launched in 1995 as an online bookstore. Brick-and-mortar bookstores were limited to about 200,000 titles and Amazon, being an online only store, without physical limitations was able to offer exponentially more products to the shopper.

Currently, Amazon offers not only books but DVDs, CDs, MP3 downloads, computer software, video games, electronics, apparel, furniture, food, and toys. A unique characteristic of Amazon's website is the user review feature that includes a rating scale to rate a product. Customer reviews are now considered the most effective social media tactic for driving sales. In 2015 Amazon surpassed Walmart as the most valuable retailer in the United States by market capitalization.

Another major success story of the original e-commerce era was eBay, an online auction site that debuted in 1995. Other retailers like Zappos and Victoria's Secret followed suit with online shopping sites; Zappos being a web-based only business.

Yahoo, Inc. began operations in 1995 followed by Google in 1998, two leading search engines in the US. These successful web directories began their own e-commerce subsidiaries with Google Shopping and Yahoo! Auction, in the years following.
Global e-commerce company, PayPal, began its services in 1998 and currently operates in 190 markets. The company is an acquired bank that performs payment processing for online vendors, auction sites, and other commercial users. They allow their customers to send, receive and hold funds in 24 currencies worldwide. Currently, PayPal manages more than 232 million accounts, more than 100 million of them active.
As more and more people began doing business online, a need for secure communication and transactions became apparent. In 2004, the Payment Card Industry Security Standards Council (PCI) was formed to ensure businesses were meeting compliance with various security requirements.

The organization was created for the development, enhancement, storage, dissemination and implementation of security standards for account data protection. The growing use of the Internet, tablet devices, and smart phones coupled with larger consumer confidence will see that e-commerce will continue to evolve and expand. With social media growing exponentially in recent years, the conversation between businesses and consumers has become more engaging, making it easier for transactional exchanges to happen online. Internet retailers continue to strive to create better content and a realistic shopping experience with technologies like virtual, augmented or mixed reality.

With mobile e-commerce gaining speed, more users are purchasing from the palm of their hand. The market for mobile payments is expected to quadruple by 2016, reaching $27.05 billion in value. Total e-commerce sales have grown from $27.6 billion in 2000 to $341.7 billion in 2015 and are estimated to grow to $523 billion by 2020.

### Brief History of Virtual Reality

1950-1970

In the mid 1950s cinematographer Morton Heilig developed the Sensorama (patented 1962) which was an arcade-style theatre cabinet that would stimulate all the senses, not just sight and sound. It featured stereo speakers, a stereoscopic 3D display, fans, smell generators and a vibrating chair. The Sensorama was intended to fully immerse the individual in a cinematic experience. He also created six short films for his invention all of which he filmed, produced and edited himself. The Sensorama films were titled, Motorcycle, Belly Dancer, Dune Buggy, Helicopter, A date with Sabina and I'm a Coca Cola bottle!

Morton Heilig's next commercial offering was the Telesphere Mask (patented 1960) and was the first example of a head-mounted display (HMD), albeit for a non-interactive film medium without any motion tracking. The headset provided stereoscopic 3D and wide vision with stereo sound.

In 1961, two Philco Corporation engineers (Comeau & Bryan) developed the first precursor to the HMD as we know it today—the Headsight. It incorporated an independent video screen for each eye and a magnetic motion tracking system, which was linked to a closed circuit camera. The Headsight was not actually developed for virtual reality applications (the term didn't exist then), but to allow for immersive remote viewing of dangerous situations by the military. Head movements would move a remote camera, allowing the user to naturally look around the environment. Headsight was the first step in the evolution of the VR head mounted display but it lacked the integration of computer and image generation.

In 1965, Ivan Sutherland published a paper describing the “Ultimate Display” concept that could simulate reality to the point where one could not tell the difference from actual reality. His concepts included:

A virtual world viewed through an HMD appearing realistic through augmented 3D sound and tactile feedback;
Computer hardware to create the virtual word and maintain it in real time; and
The ability for users to interact with objects in the virtual world in a realistic way.
“The ultimate display would, of course, be a room within which the computer can control the existence of matter. A chair displayed in such a room would be good enough to sit in. Handcuffs displayed in such a room would be confining, and a bullet displayed in such a room would be fatal. With appropriate programming such a display could literally be the Wonderland into which Alice walked.”—Ivan Sutherland′

This paper would become a core blueprint for the concepts that encompass virtual reality to this day.

In 1968 Ivan Sutherland and his student Bob Sproull created the first VR/AR head mounted display (Sword of Damocles) that was connected to a computer and not a camera. It was a large and cumbersome machine that was too heavy for any user to comfortably wear and was suspended from the ceiling (hence its name). The user would also need to be strapped into the device. The computer generated graphics were very primitive wireframe rooms and objects, but the device clearly demonstrated that creating an artificial or simulated environment was technically feasible.

In 1969 Myron Kruegere a talented computer artist developed a series of experiences for which he coined the phrase “artificial reality”. Kruegere's artificial reality incorporated computer-generated environments that could interact and respond to the people within it. The projects named “GLOWFLOW”, “METAPLAY”, and “PSYCHIC SPACE” were progressions in his research which ultimately led to the development of what he called “VIDEOPLACE” technology. This technology enabled people to communicate with each other in a responsive computer generated environment despite being miles apart.

1970-2000

Even after all these iterative steps in the development of virtual reality, there still wasn't an all-encompassing term to describe the field. This changed in 1987 when Jaron Lanier, founder of the visual programming lab (VPL), coined (or according to some popularized) the term “virtual reality”. The research field now had a lasting name. Through his company VPL, Jaron developed a range of virtual reality gear including the Dataglove (along with Tom Zimmerman) and the EyePhone head mounted display. They were the first company to sell Virtual Reality goggles (EyePhone 1 $9,400; EyePhone HRX $49,000) and gloves ($9000). The glove technology is considered to be a major development in the area of virtual reality haptics—virtual touch/sensation.

By 1991 a number of virtual reality devices began to be commercialized for consumption by the general public, although household ownership of cutting edge virtual reality was still far out of reach. The Virtuality Group launched a range of arcade games and machines. Players would wear a set of VR goggles and play on gaming machines with real-time (less than 50 ms latency) immersive stereoscopic 3D visuals. Some units were also networked together to provide a multi-player gaming experience.

Sega announced the Sega VR headset for the Sega Genesis console at the Consumer Electronics Show in 1993. The wrap-around prototype headset had head position tracking, stereo sound and LCD screens built into the visor. Sega originally intended to commercialize the product at a price point of about $200. However, significant engineering difficulties forced the company to terminate the project in the prototype phase despite Sega having created four games specifically for this product platform. Sega VR ultimately ended in commercial failure.

The Nintendo Virtual Boy (originally known as VR-32) was a 3D gaming console that was intended to be the first portable console that could display true 3D graphics. It was initially released in Japan and North America at a price of $180 (USD) but it was also a commercial failure—despite a number of price reductions. The reported reasons for this failure were a lack of color graphics (games were displayed in red and black); a lack of software support; and, it was difficult to use the console in a comfortable position. The following year commercialization was discontinued.

### 2000-Present

The first fifteen years of the 21st century has seen major, rapid advancement in the development of virtual reality. Computer technology, especially small and powerful mobile technologies, has improved exponentially while prices have declined. The rise of Smartphones with high-density displays and 3D graphics capabilities has enabled the creation of a new generation of lightweight and practical virtual reality devices. The video game industry has continued to drive the development of consumer virtual reality unabated. Depth sensing cameras sensor suites, motion controllers and natural human interfaces are already a part of daily human computing tasks.

Recently companies like Google have released interim virtual reality products such as the Google Cardboard, a DIY headset that uses a Smartphone to drive it. Companies like Samsung have taken this concept further with products such as the Galaxy Gear, which is mass produced and contains “smart” features such as gesture control.

Developer versions of final consumer products have also been available for a few years, so there has been a steady stream of software projects creating content for the imminent market acceptance of modern virtual reality products and applications.

Currently, multiple consumer devices that seem to finally address the unfulfilled promises made by virtual reality in the 1990s will be commercialized in the near future. These include the pioneering Oculus Rift, which was purchased by social media giant Facebook in 2014 for the staggering sum of $2B (USD). An incredible vote of confidence in the direction the VR/AR/MR industry is heading. The Oculus Rift will be competing with products from Valve corporation Magic Leap, HTC, Microsoft as well as Sony Computer Entertainment. These heavyweights are sure to be followed by many other enterprises, should the consumer market grow as expected.

### Prior Use of Brain Actuated Control

In the late 1980's and early 1990's researchers at the Wright Patterson, Air Force Base in Dayton Ohio developed a roll-axis tracking flight simulator that utilized a rudimentary form of brain-actuated control based on Steady-state Evoked Potentials (SSEPs). In this system, a pilot test subject was seated in a simulated cockpit environment mounted on an axle the rotation of which was controlled by an electric motor. A video monitor screen was located directly in front of the pilot that provided an artificial horizon indicating the relative bank angle of the simulator. Flanking the display screen were two small fluorescent lamps the intensity of each being modulated by a sinusoidal frequency generator. The depth of modulation could be varied from between about 20% and 80%. A diffuser screen was placed in front of the fluorescent lamps with a fenestration that permitted viewing of the display screen and artificial horizon. The flight simulator cockpit was also equipped with an EEG amplifier that connected to a lock-in amplifier system implemented using hardware components. The simulator's roll angle was controlled by the output of the lock-in amplifier such that if the output level was below a set threshold (indicating suppression of the SSEP), the simulator would incrementally roll to the left. In the event the lock-in amplifier output was above another set threshold (indicating enhancement of the SSEP), the simulator would incrementally roll to the right. A subject seated in the simulator would be able to manipulate the roll angle of the simulator by varying their individual response to the SSEP stimulus.

While the prior art is replete with examples of the utilization of VEP and SSEP in the diagnosis of visual and neurological pathologies and for conducting basic research into the fundamental workings of the brain, there is a dearth of prior art relating to the use of SSEPs in creating a practical functioning brain-to-computer interface. In the one example given above, the SSEP was utilized in a very inefficient way creating a one-dimensional signal that had significant processing delays with respect to the control requirements of the simulator (it would take many seconds to move the simulator from its maximum left bank angle to the maximum right bank angle). These types of control delays would be completely inappropriate for most VR, AR or MR applications. Additionally, only a single SSEP stimulation frequency was used to control the machine, in contrast to the needs of the present invention which would require a number of control channels due to the complexity of most VR, AR or MR applications. Likewise, there is a dearth of prior art relating to the use of other human biopotentials such as EMG and EOG—for providing a practical brain-to-computer interface. Finally, the prior art all describe apparatus for use in clinical and laboratory settings using hardware components that would be completely unsuitable for consumer applications such as a portable VR, AR or MR control system.

It is therefore an overriding object of the present invention to improve over the prior art by providing a method and apparatus by which a brain-to-computer interface may be dramatically enhanced. It is a further object of the present invention to provide such a method and apparatus that can effect brain-actuated control of an e-commerce application. It is yet another object of the present invention to provide such a method and apparatus that is simple to implement, requiring no bulky electronic systems, sub-systems and components and that can be integrated with existing virtual, augmented and mixed reality display headsets. Finally, it is an object of the present invention to provide such a method and apparatus wherein the user can dramatically increase their gratification and enjoyment of virtual/augmented/mixed reality e-commerce applications by utilizing a hands-free brain-controlled interface to navigate within and control aspects of the virtual/augmented/mixed e-commerce environments.

### SUMMARY OF THE INVENTION

In accordance with the foregoing objects, the present invention—brain actuated control of an e-commerce application—generally comprises releasably attaching a plurality of high-impedance dry Ag/Ag—Cl electrodes to selected locations on a human user's scalp; providing a low-noise, high-gain, instrumentation amplifier electrically associated with said plurality of electrodes; utilizing a high-resolution Analog-to-Digital (A/D) converter electrically associated with said instrumentation amplifier and a computer to digitize electroencephalographic signals detected by said plurality of electrodes; and, analyzing said digitized electroencephalographic signals utilizing a computer algorithm to provide control inputs to said e-commerce application, including, for example, navigation/locomotion within the virtual space, manipulation of objects such as commercial offerings, and completing selection and purchasing functions using a virtual shopping cart. The high-impedance electrodes could be incorporated in a stand-alone head band, or could be integrated into a Virtual Reality (VR) or Augmented/Mixed Reality (N MR) headgear assembly to provide convenience to the user when utilizing the system.

The high-impedance dry Ag/Ag—Cl electrodes of the present invention play an essential role in making the system easy and convenient to use. This type of electrode will be wholly preferred by the user over traditional Ag/Ag—Cl (or Au) electrodes which typically require the use of conductive gels or pastes making them difficult to both apply and remove. In order to realize this important aspect of the invention, the design and construction of the instrumentation amplifier, responsible for faithfully increasing the magnitude of the EEG/EOG/EMG signal potentials received by the electrodes, is critical and must have provisions to reject noise, such as common-mode noise, interfering exogenous electrical noise and most importantly internal noise generated by the active components of the amplifier. For example, the instrumentation amplifier of the present invention should have ultra-low internal noise specifications, e.g., input referred noise ≤22 nV/√Hz and input current noise ≤0.13 fA/√Hz. The amplifier must also utilize front-end active components with ultra-high input impedance, low current and low capacitance (≥10̂12Ω, input current ≤25 fA, input capacitance ≤1.5 pF). Owing to the significant advances made over the past two decades in operational-amplifier design and fabrication there are many suitable off-the-shelf amplifier components that can meet these requirements and that are commercially available and well known to anyone skilled in the relevant arts.

In addition to the stringent requirements for the high impedance Ag/Ag—Cl electrodes and instrumentation amplifier, the present invention will need to make use of a high resolution A/D converter, e.g., >16-bits and preferably 24-bits. The reason for this requirement is twofold. First, the number of bits used to digitally represent the analog signal determines the number of levels to which a signal can be resolved, for example, an A/D converter with 8-bits would be able to resolve an analog signal to 256 levels (2̂8=256) while a 24-bit A/D converter could resolve an analog signal to 16,777,216 levels (2̂24=16,777,216). In this way a higher resolution A/D allows for smaller variations in signal level to be detected and recorded; variations that would otherwise be lost between levels of a low-resolution A/D. Second, since the A/D is able to resolve tiny changes in input signal level, the gain requirement for the instrumentation amplifier is significantly reduced. As amplifier gain is increased there is typically an increase in complexity, noise, power consumption and instability. Therefore, the present invention will make use of one of the myriad high-resolution A/D integrated circuits that are commercially available and well known to anyone skilled in the relevant arts.

Because the present invention is intended to be integrated into an existing, commercially available, VR or A/MR headset in at least one embodiment, the electrodes and instrumentation amplifier described herein above will lend themselves well to this configuration, i.e., the components can be fitted inside said headset(s). In addition, since the VR/AR/MR headsets that are commercially available normally incorporate high-resolution display technology, a virtual e-commerce application, as described above, in combination with the present invention can readily be implemented.

The amplified and digitized signal potentials obtained from the user's scalp by way of the VR/AR/MR headset can be further processed by a computer in electrical communication with the A/D. The computer of the present invention can be separate from or, in the alternative, part of the computer used to generate the VR, AR or MR environments. In any case, a lock-in amplifier system or other detection algorithm can be implemented entirely in software and utilized to analyze the digitized EEG/EOG/EMG biopotentials enabling detection and quantization of signals resulting from the user generating explicit control inputs. The output signal(s) from the software-derived lock-in amplifier system, or detection algorithm can subsequently be used within the VR/AR/MR environment for operations such as navigation/locomotion within and control of myriad operational aspects of the simulation. By way of example, a user could make a purchase within an e-commerce VR/AR/MR application by modulating concentration levels; tensing/releasing specific muscle groups; moving the eyes in relation to a desired commercial offering; or, focusing on a desired commercial offering that has been encoded with an SSEP visual stimulus. When the lock-in amplifier or detection algorithm generates an output signal indicative of the user's intention towards a specific commercial offering, a “shopping cart” could appear giving the user an option to purchase the item. The user could indicate his/her preference again by the means described above, e.g., one signal indicating “purchase” and another signal indicating “cancel”. In the foregoing example, the entire commercial transaction could take place using only brain-actuated control and would not require the user to take any other action, such as using a mouse or keyboard. In fact, it is believed that a brain-actuated control method of the present invention can provide an interface that is significantly more natural than any other method with respect to a VR, AR or MR environment.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

FIG. 1 shows a block diagram of an aspect of the present invention for brain actuated control of an e-commerce application.

FIG. 2 shows in flow diagram a representation of the general processing steps of the present invention.

FIG. 3 shows in exploded view a representation of the head-gear with integrated Ag/Ag—Cl electrodes utilized with the present invention.

FIG. 4 shows in functional block diagram an instrumentation amplifier and filtering system of the present invention.

FIG. 5 shows in functional block diagram a lock-in amplifier system of the present invention.

FIG. 6 shows in flow diagram a representation of the general processing steps of the present invention for virtual e-commerce applications.

FIG. 7 shows an exemplar of a 3D representation of a virtual e-commerce application and virtual shopping cart of the present invention.

### DETAILED DESCRIPTION OF THE PREFERRED EMBODIMENT

Although those of ordinary skill in the art will readily recognize many alternative embodiments, especially in light of the illustrations provided herein, this detailed description is of the preferred embodiment of the present invention, brain actuated control of an e-commerce application, the scope of which is limited only by the claims appended hereto.

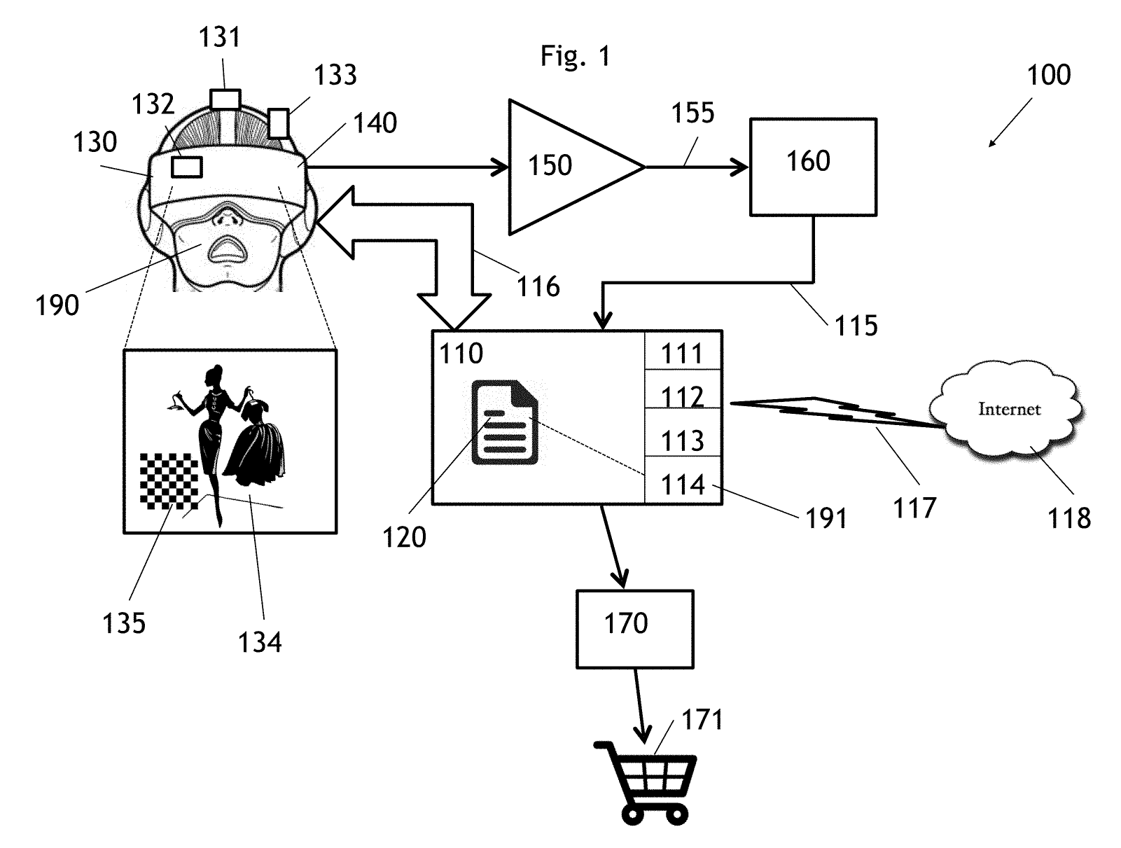

As particularly shown in FIG. 1, an apparatus for brain actuated control of an e-commerce application of the present invention is referred to by the numeral 100 and generally comprises a computer-based device 110, software stored within computer-based device for performing the steps of the invention 120, Virtual Reality (VR), Augmented Reality (AR) or Mixed Reality (MR) headgear 130, integrated Ag/Ag—Cl electrode array 140, biopotential amplifier 150, Analog-to-Digital converter 160, and virtual e-commerce application 170.

Referring now to FIG. 1, a method and apparatus for brain actuated control utilizing steady-state evoked potentials includes a computer 110 well known in the art and commercially available under such trademarks as “IBM®”, “Compaq®”, and “Dell®” having a central processor (CP) 111 which is also well known in the art and commercially available under such trademarks as “Intel® 486”, “Pentium®” and “Motorola 68000”, conventional non-volatile Random Access Memory (RAM) 112, conventional Read Only Memory (ROM) 113, and magnetic disk storage device(s) 114. Computer 110 can be configured as a standard PC, or can be implemented as a custom single-board computer utilizing an embedded operating system such as is sold commercially under the trademark Windows NT®. Likewise, computer 110 could be a smart-phone or derivative thereof well known in the art and commercially available under the trademarks “iPhone®” and “Android®”. Computer 110 can be utilized by the present invention in a stand-along configuration, or alternatively connected to the Internet 118 via a LAN or WiFi or other electronic data-interchange connection 117, for example. Computer 110 is operably associated with communications channel 115 which can be a conventional RS-232, USB or another equivalent bi-directional communications port. Communications channel 115 has associated therewith an Analog-to-Digital converter 160 which can be one of myriad devices that are known to anyone of ordinary skill in the art. A/D converter 160 should be of a high-resolution type with not less than 8 bits and preferably 24 bits or more. The Analog-to-Digital converter 160 and communications channel 115 are responsible for converting the analog human biopotential signals into a digital representation that can be subsequently processed by computer 110. Computer 110 is further operably associated with disk storage device(s) 114 comprising a file system utilized in storing the software 120, and, optionally, human biopotential data 191. Computer 110 is also electrically associated with a MR/ARNR headgear device 130 which is well known in the art and available under the trademark “HoloLens®” for example. Computer 110 connects to the headgear device 130 via a second communications channel 116. This channel provides visual data to headgear device 130 to be viewed by the user. This data can include for example 3D virtual renderings of people, places or things 134. Additionally, communications channel 116 connects various position tracking sensors including a head tracking sensor 131, eye tracking sensor 132 and optionally GPS sensor 133 to computer 110. Headgear device 130 typically has associated with it a high-resolution monitor such as an LCD, LED or other display device, all of which are well known in the art, said monitor designed to present images to a human subject 190. Headgear device 130 has a plurality of Ag/Ag—Cl electrodes 140 associated therewith wherein said electrodes 140 are removably associated with said human subject 190 the particulars of which are described hereinafter. A biopotential amplifier 150 and an analog communications channel 155 which transmits three analog data types (EEG, EOG and EMG) is electrically associated with the Analog-to-Digital converter 160. Biopotential amplifier 150, communications channel 155 and Analog-to-Digital converter 160 can comprise one or more channel(s). The preferred embodiment of the present invention includes at least one channel. Collectively, these elements (150-160) can be housed within headgear 130 to minimize the bulk and complexity of the system or can be remotely located from headgear 130. Headgear device 130 also has the capability of projecting one or more visual stimuli 135, if desired, which in the example depicted is an alternating checkerboard pattern. Visual stimuli 135 is configured to be a steady-state visual stimuli designed to generate an SSEP (detected by electrode array 140 and biopotential amplifier 150) in the event subject 190 is focused on one or more of said stimuli 135. Stimuli 135 can be associated with one or more people, places or things 134 to enable, for example, user 190 to select one or more of said people, places or things by producing an SSEP in response to said stimuli 135. In this way, the user 190 can effect brain actuated control on of a virtual e-commerce application 170. The virtual e-commerce application 170 of the present invention could all be part of a virtual, augmented or mixed reality simulation. By way of example with respect to virtual e-commerce application 170, headgear 130 could project a virtual, augmented or mixed reality shopping mall with a commercial offering such as a dress or other article of clothing 134 along with an associated steady-state stimulus 135 that would be viewed by user 190 who is wearing the headgear and accessing the e-commerce application 170. A user 190 could focus his/her attention on said stimulus 135 indicating an interest in commercial offering 134 which subsequently would signal the computer 110 to place the offering 134 into a shopping cart 171 for later purchase. Likewise a user 190 could generate a physiological signal such as an EMG or EOG biopotential signal indicating an interest in a particular commercial offering 134 which subsequently would signal the computer 110 to place the offering 134 into a shopping cart 171 for later purchase.

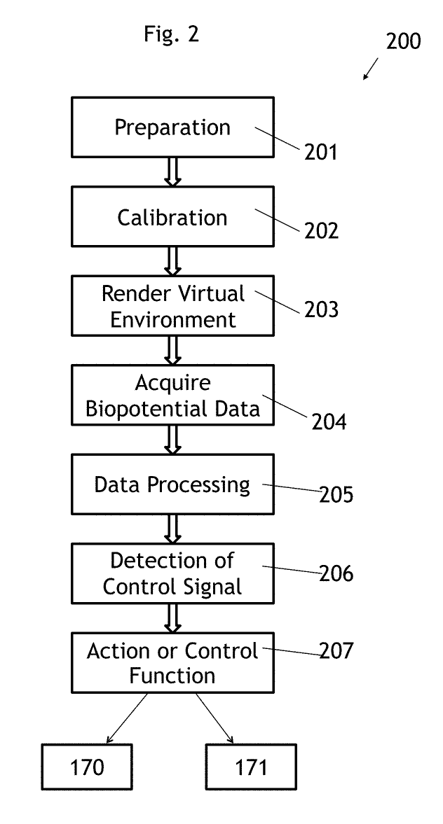

It is readily apparent based on these examples that the brain actuated control system 100 depicted in FIG. 1 could effect many forms of brain actuated control in this way including causing navigation/locomotion within a virtual e-commerce environment, selecting, examining and purchasing commercial offerings, and requesting information about a particular commercial offering, a person, place or thing within said virtual e-commerce environment. As shown in FIG. 2, the general processing steps 200, appropriate for implementation of the present invention includes preparation step 201, calibration step 202, rendering virtual environment step 203, acquiring biopotential data (EEG, EOG, EMG) step 204, data processing step 205, detection of control signal step 206 and output of an action or control function step 207.

Before utilizing the brain actuated control system of the present invention, the user 190 is prepared in step 201. This step consists of cleaning the scalp (forehead, occipital lobe region or other contact regions associated with Ag/Ag—Cl electrodes 140) by gently abrading with an appropriate preparation solution well known to anyone of ordinary skill in the art, cleaning the plurality of electrodes 140 with a mild soap solution or alcohol, placing the headgear on the head of user 190 and connecting the communications cable 116 to computer 110 and electrodes 140 to biopotential amplifier 150. Note that electrodes 140 and communications cable 116, and optionally computer 110 may be integrated into the headgear 130 obviating the need to connect these components prior to use. Likewise, it is possible to apply electrodes 140 to user 190 without cleaning the contact areas of the scalp. These exemplary steps are provided to enable user 190 to optimize the performance of the brain actuated control system.

With the user connected to biopotential amplifier 150, software 120 is started whereupon calibration step 202 is subsequently performed. In this step, the software 120 automatically adjusts the amplifier gains and resting baselines to create an individualized signal envelope for one or more of the three analog biopotential types (EEG, EOG and EMG) transmitted through communications channel 155. This calibration step 202 maximizes the dynamic range of the signal and prevents high-end saturation for large potential swings while ensuring enough gain is applied for the proper amplification of the signal. It should be noted that general processing steps 201 and 202 can be performed by the user 190 alone or with the help of one or more assistants.

With the brain actuated control system 100 now prepared for use, step 203 is performed wherein software associated with e-commerce application 170 is started. In either case, the said software will render a virtual or mixed reality environment that user 190 can view and interact with via headgear 130. Headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 130 to view and interact with the virtual/augmented/mixed environment in a natural way.

Next, step 204 acquires biopotential data from user 190 via the electrodes 140, biopotential amplifier 150 and A/D 160. This data can include EEG, EOG and EMG biosignals. The data can further be stored, if needed, within computer 110 as described hereinabove. The biopotential data acquired in step 204 will subsequently be used by software 120 to produce at least one control signal; for example, said control signal can be one of an action or function control signal. By way of example, an action control signal could create navigation/locomotion within e-commerce application 170 while a function control signal could be utilized by the present invention to view a commercial offering, and/or subsequently place said commercial offering into shopping cart 171 if so desired by user 190.

Data processing step 205 of the present invention preferably utilizes a lock-in amplifier 500 as a digital signal processing technique the particulars of which are described hereinafter. After the user's 190 biopotential data is acquired it must be processed and analyzed to determine the presence or absence of a control signal. The lock-in amplifier 500 can be implemented as part of software 120 in the form of an algorithm described in greater detail below and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency and each producing at least one control signal. Since brain function produces signals that can be grouped into discrete bands of frequencies, the lock-in amplifier provides a way to discern information about what the brain is doing at any given point in time. The output signal of processing step 205 is preferably in the form of an analog value the magnitude of which is representative of the strength of the control signal resulting from the user 190 altering his/her physiological activity. This signal is utilized by subsequent steps to determine the presence or absence of one or more control signals and their type.

Processed data from step 205 is utilized by step 206 to make a determination with respect to the presence or absence of control signal in response to the physiological state of user 190. This step in its simplest form can be configured as a linear threshold detector wherein if the output signal level of lock-in amplifier 500 is greater than a pre-determined threshold value, the presence of a control signal is indicated. Likewise if the output signal level of lock-in amplifier 500 is lower than a pre-determined threshold value, the absence of a control signal is alternately confirmed. The algorithm utilized by step 206 can include non-linear methods, for example basing the decision of presence or absence of a control signal on the square of the output signal from lock-in amplifier 500, or setting multiple thresholds with different activities assigned to each of the ranges between said thresholds. Likewise if the control signal generated in step 205 is analog the magnitude of the signal could be used to modulate a locomotion speed within e-commerce application 170, for example. Other variables can be taken in consideration by step 206 for example, head position, eye tracking and GPS location could all play a part in the detection process.

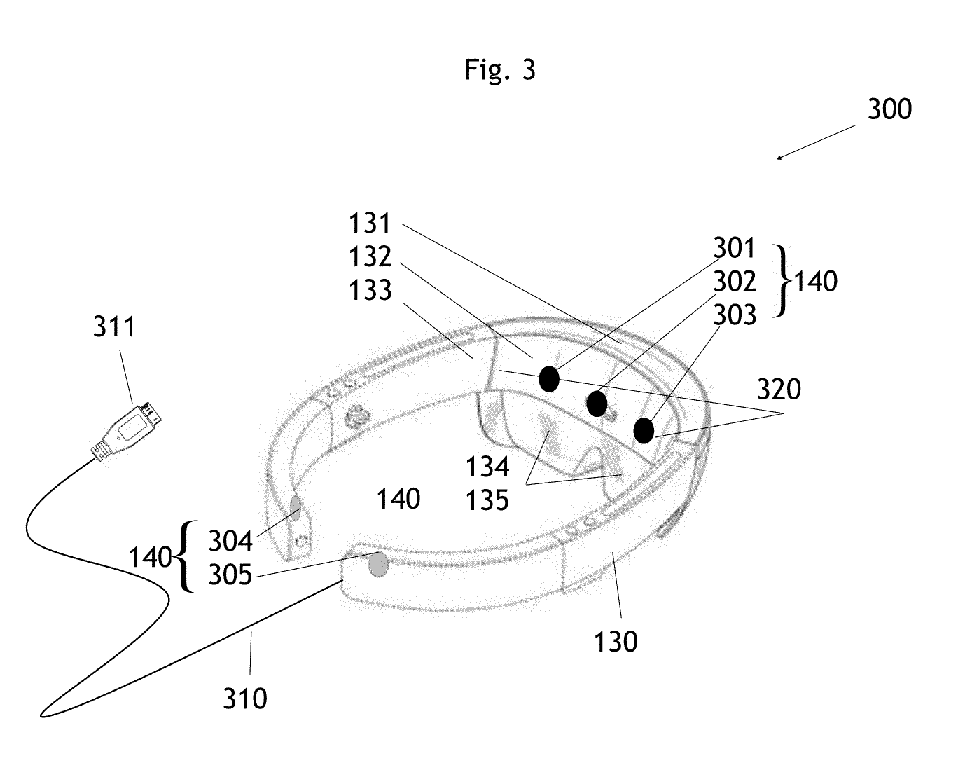

Finally, action or control function step 207 performs an activity relating to control of e-commerce application 170 based on the determination(s) made by detection step 206. This activity can be one or more of a myriad of things including but not limited to: navigation/locomotion; selecting, examining and purchasing commercial offerings; and, requesting information about a particular commercial offering, a person, place or thing within the virtual environment of e-commerce application 170. Step 207 could provide multiple control signals, for example, one type of control signal for moving forward, another for moving backwards another for moving left and yet another for moving right. By way of example, step 207 could provide software instructions to an e-commerce application causing a virtual or mixed reality character to run, walk, sit, try on clothes or jewelry, interact with virtual store clerks, other shoppers, friends or family members. While these foregoing steps outline an exemplar method to implement the brain actuated control system of the present invention, they are not intended to limit the scope of the present invention. It will be readily apparent to those of ordinary skill in the art that myriad combinations and permutations of the steps detailed hereinabove can be employed in a suitable fashion to substantially derive the same or similar outcomes. Reference is now made to FIG. 3, an exploded view of a representation 300 of the headgear 130 of the present invention. As can be seen in the drawing, the headgear 130 consists of MR, AR or VR “goggles” which can be one of many known by those of ordinary skill in the art and commercially available under the trademarks “Oculus Gear VR®”, “HoloLens®” or “Magic Leap™” for example, and may include a head position sensor 131, eye tracking sensor 132 and GPS locator 133. The headgear 130 may have one of, all of, or none of the foregoing sensors and still be used by the present invention. In addition to the aforementioned sensors, a plurality of electrodes 140 preferably of the Ag/Ag—Cl type are arrayed along the front (301-303) and back (304-305) of headgear 130 in such a way as to permit contact with the scalp of a user 190 when the headgear 130 is placed on the head of said user 190. The present invention could be used with as few as two electrodes but preferably has three or more electrodes in contact with the scalp of user 190. The electrodes 140 can be of any desirable shape or size provided they fit within the confines of the headgear 130. For the present invention, the preferable shape of the electrodes 140 is round and the preferable size range is between 0.250″ and 0.750″. Smaller or larger electrodes are perfectly acceptable as long as they are able to have adequate contact with the user's 190 scalp and provide a usable signal without creating excessive noise. A flexible cable 310 and multi-contact connector 311 are provide to connect electrodes 140 to biopotential amplifier 150 described in detail hereinabove.

The electrodes 140 can be of a permanent or replaceable type enabling the user to renew one or more electrodes that have developed wear, corrosion or another defect making them unsuitable for use with the present invention. The electrodes can be positioned to contact various areas of interest of the scalp as a means to collect aggregate EEG, EOG and EMG data underlying the electrode's position on the scalp. For the present invention, it is preferred to locate electrodes 140 over the frontal (301-303) and occipital (304-305) regions of the brain, the occipital being particularly important when working with SSEPs. The electrodes 140 can be mounted directly to receptacles located on headgear 130, or can be mechanically attached to a separate head-band 320 that is removably attached to headgear 130. A separate headband 320 can be fabricated from a rigid material such as plastic, a semi-rigid material such as rubber or elastic, or a flexible material such as cloth or leather. The principal function of separate headband 320 is to hold the electrodes 140 respectively in stable proximity to each other and to specific locations on the user's scalp while minimizing the potential for artifact caused by movement of the electrodes over the surface of the scalp. The front edge of separate headband 320 is removably affixed to the front central portion, sides and rear portion of headgear 130. In this way, the headband 320 can be removed and periodically washed if needed. For the preferred embodiment of the present invention, the electrodes 140 are fabricated from Ag/Ag—Cl plated carbon-filled plastic. It will be evident to anyone of ordinary skill in the art that myriad other types of electrodes can be satisfactorily utilized by the brain actuated control system 100 including gold/gold-plated electrodes, for example. The front part of electrode array 140 is generally positioned above the Frontal lobe and across the forehead of user 190 with a reference electrode 302 preferably positioned above FPZ, signal electrode 301 preferably positioned above FP1 and signal electrode 303 preferably positioned above FP2 in accordance with the International “10-20” system. The rearward part of electrode array 140 is generally positioned above the Occipital lobe near the back of the head of user 190 with a signal electrode 304 preferably positioned above O1 and a signal electrode 305 positioned above O2 also in accordance with the “10-20” system for electrode placement.

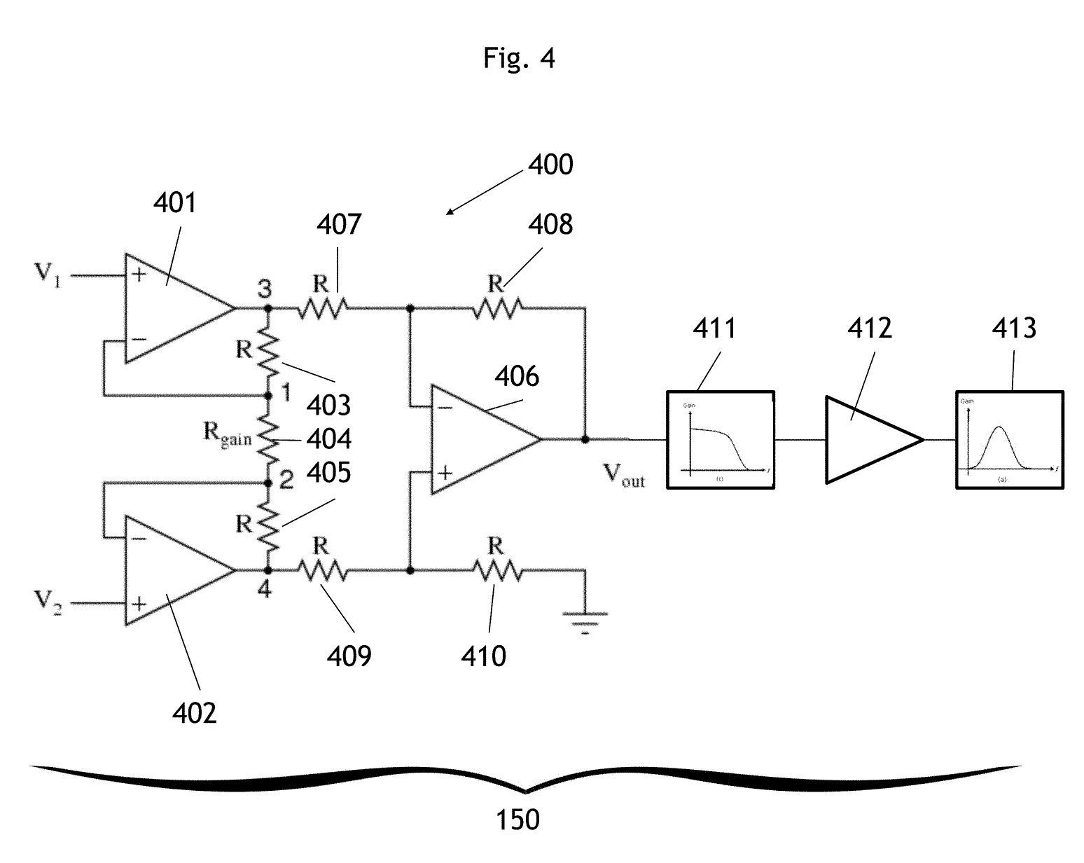

Although there are many combinations and permutations for utilizing the above described electrode arrays 140, in general, electrode 302 which is centrally located within its respective array (301-303) is utilized as the “reference” electrode creating a common-mode rejection configuration to reduce global noise and artifacts. Electrodes 301-303 and 304-305 removably positionable on headgear 130 or separate headband 320 are electrically associated with cable 310 and connector 311. Lead wires attaching to individual electrodes 301-305 are combined to form the cable harness 310 which is preferably shielded to minimize extraneous electrical noise and interference. Cable 310 is preferably removably associated with biopotential amplifier 150 utilizing a common off-the-shelf connector 311 which is readily available and well known to anyone of ordinary skill in the art. Cable 310 is of a suitable length to permit headgear 130 to move freely without interference from any part of the system it is connected to. In this way, the biopotential signals from each of electrodes 301-305 making up electrode array 140 are communicated to biopotential amplifier 150 via cable 310. As further described in detail herein, biopotential amplifier 150 could be integrated directly into headgear 130 or separate headband 320 if so desired to dramatically shorten the length of cable 310 and further reduce the extraneous electrical noise or interference.
Referring now to FIG. 4, a circuit diagram representation 400 of one or more channels for biopotential amplifier 150 as described in detail hereinabove; it is desired that biopotential amplifier 150 have various characteristics conducive to the use of dry Ag/Ag—Cl electrodes which by necessity will have a very high contact impedance with the scalp. To that end, the biopotential amplifier 150 will require ultra-low internal noise specifications, e.g., input referred noise ≤22 nV/√Hz and input current noise ≤0.13 fA/√Hz. The amplifier must also utilize front-end active components with ultra-high input impedance, low current and low capacitance (≥10̂12Ω, input current ≤25 fA, input capacitance ≤1.5 pF). In addition, biopotential amplifier 150 must have excellent common-mode noise rejection. Accordingly, biopotential amplifier 150 is preferably configured as an “instrumentation amplifier”. The instrumentation amplifier “front-end” of biopotential amplifier 150 can be constructed from discrete components or can be a single integrated circuit, such as an AD-620 well known to anyone of ordinary skill in the art and commercially available under the trademark “Analog Devices®”, for example. The instrumentation amplifier of the present invention is constructed from a buffered differential amplifier stage 406 with three resistors 403-405 linking the two input buffer circuits 401 and 402 together. If resistors 403, 405 and 407-410 are of equal value, the negative feedback of the upper-left operational amplifier 401 will cause the voltage at point 1 (the junction of resistor 403 and resistor 404) to be equal to the input voltage from one of the signal electrodes 140 (designated V1). Likewise, the negative feedback of the lower-left operational amplifier 402 will cause the voltage at point 2 (the junction of resistor 404 and resistor 405) to be equal to the input voltage from another of the signal electrodes 140 (designated V2). This establishes a voltage drop across resistor 404 equal to the voltage difference between V1 and V2. That voltage drop causes a current through resistor 404 and since the feedback loops of the two input operational amplifiers 401 and 402 draw no current, that same amount of current through resistor 404 must be flowing through the resistor 403 and resistor 405 above and below it. This produces a voltage drop between points 3 and 4 equal to:

$${V}_{3 \text{-} 4} = ( {V}_{2} - {V}_{1} ) ( 1 + \frac{2 R}{{R}_{gain}} )$$

Operational-amplifier 406 configured as a standard differential amplifier on the right-middle of the circuit then takes this voltage drop between points 3 and 4 and amplifies it by a pre-determined gain factor. This instrumentation amplifier configuration has the distinct advantage of possessing extremely high input impedances on the V1 and V2 inputs (because they connect directly to the non-inverting inputs of their respective operational-amplifiers 401 and 402), and adjustable gain that can be selected by adjusting the value of a single resistor 404. Making use of the formula provided above, a general expression for overall voltage gain of the instrumentation amplifier is:

$${A}_{V} = ( 1 + \frac{2 R}{{R}_{gain}} )$$

It becomes apparent by viewing the schematic of FIG. 4. that the gain of the instrumentation amplifier could also be changed by changing the values of some of the other resistors. This, of course, would necessitate balanced resistor value changes in order for the circuit to remain symmetrical. Thus the gain of the amplifier is typically set by selecting a specific value for resistor 404 only. With respect to the present invention, a preferred value range of the gain of instrumentation amplifier 400 is between 10 and 40. Since the electrodes 140 are metalized and in contact with living tissue containing electrolytes, it is possible for the interaction to produce small voltages that will drive the operational amplifiers 401, 402 and 406 into saturation if the overall gain is set too high. In the present invention, the remaining stages of biopotential amplifier 150 are A.C. coupled to the instrumentation amplifier to prevent any D.C. offset voltages to be presented to succeeding stages. Since the biopotentials being amplified by biopotential amplifier 150 are in the order of 10̂-6 to 10̂-3 volts, additional gain and filtering stages are needed to produce a signal usable by the present invention. To that end, three exemplar follow-on stages are shown in FIG. 4. These stages include: low-pass filter 411, amplifier gain-stage 412 and band-pass filter 413. Low-pass filter 411 can be passive or active and is well known to anyone of ordinary skill in the art. Preferably a two-pole “Sallen-Key” type active filter using a single operational-amplifier would be used in the present invention as low-pass filter 411. Amplifier gain-stage 412 could be configured as one or more inverting or non-inverting operational-amplifiers each having a gain in the range of 10 to 100. For the present invention, the gain of amplifier 412 is preferably ˜50. Finally, a band-pass filter 413 can be employed and can be of many configurations well known in the art including a “Butterworth” filter, “Chebyshev” filter, or an “Infinite Gain Multiple Feedback” (IGMF) filter. The band-pass filter 413 can be configured to have any desired gain, or can be a unity-gain filter. Likewise, additional filtering or gain stages can be added sequentially to the signal chain of biopotential amplifier 150 the objective being to produce a conditioned signal suitable for use in effecting brain actuated control of the present invention.

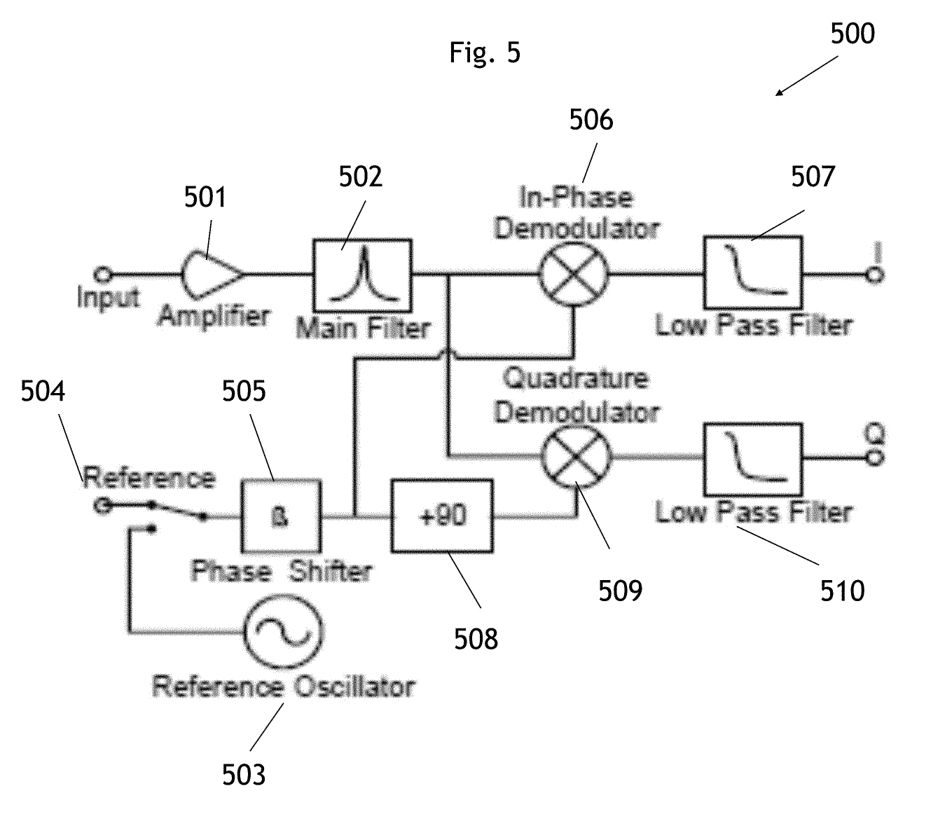

FIG. 5 depicts a block-diagram representation of a conventional “lock-in” amplifier 500 of the present invention. Lock-in amplifier 500 can be implemented utilizing hard-wired electronic components (hardware) or entirely as a software algorithm. The preferred embodiment of the present invention utilizes a software-derived lock-in amplifier system 500 to reduce parts count and associated cost; facilitate real-time changes to amplifier parameters; and, permit the creation of multiple instantiations of lock-in amplifier 500 at different frequencies without incurring additional cost. The lock-in amplifier system consists of an input amplifier stage 501 that increases the magnitude of the signal to a suitable level for further manipulation if necessary. Likewise, amplifier stage 501 could perform an impedance conversion in the process as well. In a hardware implementation, amplifier 501 could be a transistor circuit or operational-amplifier or the like; for a software implementation, amplifier 501 can be modeled by multiplying the discrete input signal by a constant gain factor “G”. A band-pass filter 502 can be employed to remove any signal components that are either at the D.C. level or at harmonics of the signal to be measured to help prevent aliasing. In a hardware implementation, band-pass filter 502 can be one of many well known to anyone of ordinary skill in the art and described in detail hereinabove; for a software implementation, band-pass filter 502 could be, for example, a software-derived Finite Impulse Response (FIR) filter or Infinite Impulse Response (IIR) filter, for example. The next stage of lock-in amplifier 500 is the in-phase demodulator 506 also known as a synchronous demodulator or simply “mixer”. This system element can take many forms, from a logarithmic amplifier to dedicated four-quadrant multiplier. In any case with either a hardware or software implementation, the processed input signal is multiplied by a reference signal from a sinusoidal oscillator 503 or an optional external reference 504 and a phase-shift element 505. Since the reference signal must maintain a fixed-phase relationship to the input signal, it can optionally be locked to the reference signal using a Phase-Locked Loop (PLL) (not shown). A quadrature demodulator 509 is also provided which mixes the processed input signal with a 90 degree phase-shifted version of the reference 508. This addition has the useful property that it is then quite simple to directly calculate the magnitude of the input signal and its phase relationship to the reference signal. These two separate “channels” are normally referred to as the “I” component and the “Q” component respectively. There are myriad electronic hardware components available and well known to anyone of ordinary skill in the art to implement the in-phase demodulator 506, quadrature demodulator 509 and 90 degree phase-shift element 508 of the present invention; for software, both demodulators and phase-shift element 508 can be implemented using simple trigonometric functions.

Finally, the output from the in-phase demodulator 506 and quadrature demodulator 509 are fed into low-pass filters 507 and 510 respectively which effectively removes any non-coherent signals leaving a D.C. signal that is proportional to the amplitude and phase of the original input signal with respect to the reference signal. Since the present invention is primarily concerned with the presence and magnitude of a targeted band of biopotential signal frequencies, the power spectrum for the input signal with respect to the reference signal can be derived as follows:

Mₚₛ=√(I²+Q²)

This signal can be utilized by processing step 207 of the present invention described in detail hereinabove to make a determination with respect to the presence or absence of a specific target biopotential signal.

As described above, the present invention can utilize either a hardware or software implementation of the lock-in amplifier system 500 but for the reasons given, a software implementation is preferred. There are a number of problems with analog lock-in amplifiers. For the highest accuracy, the reference signal must have a very low harmonic content. In other words, it must be a very pure sine wave since any additional harmonic content will likely cause distortion at the output. Analog sine wave generators can also suffer from frequency, amplitude and phase variations that would also introduce potentially distorting artifacts. On the other hand, a sine wave generator can be implemented in software simply by using a Sine or Cosine trigonometric function. Since the signal generated by said function is ideal, there can be no variation of frequency, amplitude or phase.

It is clear from the foregoing description that many variations, combinations and permutations of the various hardware and software elements described in FIG. 5. as part of lock-in amplifier system 500 could be employed in a suitable fashion to substantially derive the same or similar outputs. Therefore, the arrangement given is an exemplar method to implement a lock-in amplifier 500 of the brain actuated control system of the present invention and is not intended to limit the scope of the present invention. In addition, to implement certain aspects of the present invention, such as, for example, deriving a signal associated with locomotion in the virtual e-commerce application, a simple hardware or software filtering system (e.g., multi-pole bandpass filter) could be employed with an envelope detector coupled to a threshold detector. If the predetermined threshold is exceeded a signal indicative of locomotion (forward/backward) could be produced. Likewise if the threshold is not exceeded the user could remain stationary within the virtual environment. This and myriad other signal analysis techniques, well known to anyone of ordinary skill in the relevant arts could be employed without departing from the scope of the present invention.

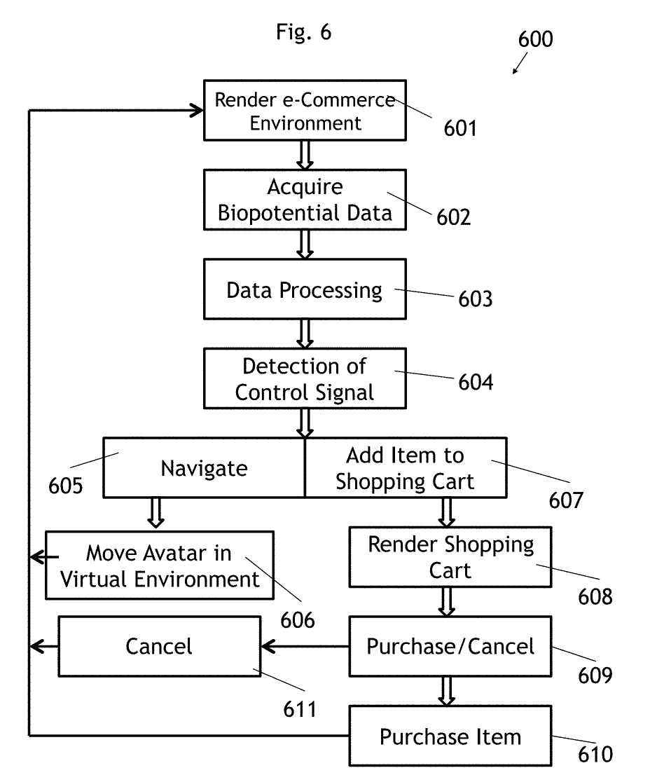

As shown particularly in FIG. 6, a flow diagram representation of the general processing steps 600 of the present invention for virtual e-commerce applications includes: render e-commerce environment step 601, acquire biopotential data step 602, data processing step 603, detection of control signal 604, navigate step 605, move avatar in virtual environment step 606, add item to shopping cart step 607, render shopping cart step 608, purchase/cancel step 609, purchase item step 610 and cancel step 611.

With the brain actuated control system 100 prepared for use as described in further detail hereinabove (FIG. 2), step 601 is performed wherein software associated with an e-commerce application 170 is started. The virtual e-commerce simulation software will render a virtual, augmented or mixed reality environment that user 190 can view and interact with via headgear 130. Also as described above, headgear 130 optionally includes myriad sensors to facilitate this interaction including head position sensor 131, eye position sensor 132 and GPS sensor 133. These sensors can work alone or in conjunction with each other to provide control inputs to computer 110 and enable the user 130 to view and interact with the virtual/augmented/mixed environment in a natural way. It is anticipated that software 170 shall communicate with or be operating within a server that is distal from user 190. Accordingly it is within the scope of the present invention to render a shared virtual e-commerce environment with multiple users 190, each of whom would view the virtual e-commerce environment from a first-person perspective and would further view other human users 190, also within the shared environment, as a representative avatar. Thus, for example, it will be possible, within the scope of the present invention, for friends or family members to “shop” together and interact with each in the virtual or mixed e-commerce environment. Likewise, a live human or computer-derived virtual store clerk could be rendered in the virtual environment to assist one or more users 190. In any event, step 601 is responsible for rendering this environment in all its complexity and detail. Likewise, step 601 is envisioned rendering a virtual “mirror” within the virtual e-commerce environment that would permit user 190 to view his/her representative avatar. This feature would be especially useful to enable viewing oneself wearing virtual clothing, jewelry or makeup, for example.

Subsequent the rendering of the virtual e-commerce environment in step 601, step 602 acquires biopotential data from user 190 via the electrodes 140, biopotential amplifier 150 and A/D 160. This data can include EEG, EOG and EMG biosignals. The data can further be stored, if needed, within computer 110 as described hereinabove. The biopotential data acquired in step 602 will subsequently be used by software 120 to produce at least one control signal; for example, said control signal can be one of an action or function control signal. By way of example, an action control signal could create navigation/locomotion within e-commerce application 170 while a function control signal could be utilized by the present invention to view a commercial offering, and/or subsequently place said commercial offering into shopping cart 171 if so desired by user 190.

Data processing step 603 of the present invention preferably utilizes a lock-in amplifier 500 as a digital signal processing technique the particulars of which are described hereinabove. After the user's 190 biopotential data is acquired it must be processed and analyzed to determine the presence or absence of a control signal. The lock-in amplifier 500 can be implemented as part of software 120 in the form of an algorithm described in greater detail above (FIG. 5), and is well known to anyone of ordinary skill in the art, and for the preferred embodiment, functions as a very-high Q filter. The lock-in amplifier 500 computes a time-history of the power spectrum for a single predetermined frequency in near real-time. Multiple instantiations of lock-in amplifier 500 can be run concomitantly on computer 110, each with a unique pre-determined frequency and each producing at least one control signal. Since brain function produces signals that can be grouped into discrete bands of frequencies, the lock-in amplifier provides a way to discern information about what the brain is doing at any given point in time. The output signal of processing step 603 is preferably in the form of an analog value the magnitude of which is representative of the strength of the control signal resulting from the user 190 altering his/her physiological activity. This signal is utilized by subsequent steps to determine the presence or absence of one or more control signals and their type.

Processed data from step 603 is utilized by step 604 to make a determination with respect to the presence or absence of control signal in response to the physiological state of user 190. This step in its simplest form can be configured as a linear threshold detector wherein if the output signal level of lock-in amplifier 500 is greater than a pre-determined threshold value, the presence of a control signal is indicated. Likewise if the output signal level of lock-in amplifier 500 is lower than a pre-determined threshold value, the absence of a control signal is alternately confirmed. The algorithm utilized by step 206 can include non-linear methods, for example basing the decision of presence or absence of a control signal on the square of the output signal from lock-in amplifier 500, or setting multiple thresholds with different activities assigned to each of the ranges between said thresholds. Likewise if the control signal generated in step 603 is analog the magnitude of the signal could be used to modulate a locomotion speed within e-commerce application 170, for example. Other variables can be taken in consideration by step 604 for example, head position, eye tracking and GPS location could all play a part in the detection process.

While it is conceivable that myriad activities with respect to user(s) 190 would be permissible within the scope of the virtual/augmented/mixed reality environment of the present invention, for purposes of this example, the forgoing discussion is limited to navigation/locomotion within the virtual space and the activity of adding/purchasing a commercial item with a virtual shopping cart 171. Navigation step 605 is responsible for providing the means by which user 190 chooses where in the virtual e-commerce environment user 190 wishes to move and step 606 subsequently produces the semblance of locomotion within the simulated e-commerce environment as a response to said navigation step 605. Navigation step 605 and move avatar step 606 permits user 190 to move about the virtual environment and view said environment from various first-person perspectives. This includes viewing the construction of the virtual space itself, such as visiting individual “shops” or “stores” (e.g., a “mall” environment) or observing commercial offerings within the environment such as products, advertisements and the like. In any case, step 605 has the primary function of identifying where within the virtual environment user 190 wishes to move when user 190 produces a directional control signal. This directional control signal can be created by, for example, head tracking sensor 131, eye tracking sensor 132, or GPS sensor 133 when user 190 changes head position, looks in a different direction or physically moves in the real world. Likewise, EEG, EOG or EMG biopotentials could be utilized to provide a directional signal, e.g., if user 190 moves his/her eyes to look in a different direction an EOG signal indicative of this action can be readily obtained. Finally, navigational waypoints could be created by utilizing one or more of the means described and affixed by user 190 to different parts of the simulation. An optional SSEP could be employed by visually encoding various features of the simulation permitting point-to-point navigation. It should be noted that while the preferred embodiment described herein uses head position tracking to facilitate navigation within the simulated environment, it is also feasible to utilize myriad other methods to accomplish the same function. Accordingly, the foregoing description is not intended to limit the scope of the present invention. Locomotion step 606 of the present invention relies on an action control signal from user 190 that is preferably an EEG or EMG biopotential. When user 190 produces predetermined changes in physiological activity indicative of the desire to move, the avatar of user 190 moves within the virtual environment and the point-of-view of user 190 changes accordingly. The physiological changes may include but are not limited to, producing a particular brainwave pattern (e.g., Alpha rhythm); activating facial muscles; or, generally increasing tension in the muscles of the scalp. It should be noted that user 190 can both navigate (step 605) and locomote (step 606) simultaneously and create the strong impression of natural movement within the virtual environment. By way of example, if user 190 continually produces an action signal indicative of locomotion while simultaneously changing head position, the avatar can be made to move in any direction the user is “looking” and change direction in response to said head movement while moving.

Each time any user 190 moves within or moves an object, such as a commercial offering, within said virtual e-commerce environment, the rendering of the environment and follow-on steps will be repeated in a loop as denoted by the various arrows in the flow diagram depicted in FIG. 6.

Once user 190 has completed the desired navigation/locomotion steps 605 and 606 respectively and desires to purchase, for example, a commercial offering 134 such as a product or service, step 607 provides the means by which said commercial offering can be added to a virtual shopping cart 171 of the present invention. In one implementation of step 607, user 190 selects one or more commercial offerings 134 by effecting a change in physiological state, such as, for example rapidly glancing left or right one or more times to create a function control signal indicative of the desire to make a particular selection. In an alternative implementation of step 607, and as described in detail hereinabove (FIG. 1), one or more visual stimuli 135 can be associated with one or more commercial offerings 134 that are subsequently identified and selected when user 190 produces an SSEP in response to said stimuli 135. Upon detection of an SSEP in response to a commercial offering step 607 can add said commercial offering to a virtual shopping cart 171 the particulars of which are described below.

Step 608 renders the shopping cart 171 in the 3D virtual space and step 609 provides options to the user that can be selected by using, for example, a computer pointing tool controlled by head position. The options of step 609 can include, for example, immediate or delayed purchase of said commercial offering, providing a method of payment, selecting customizable product features, selecting product quantities or cancelling the purchase altogether. At this stage in the process, the state of the virtual environment changes from a “navigate/locomote” to a “procurement” state with control of the simulation being passed to step 609.

Once the user 190 has made a decision with respect to one or more selections provided via step 609 an affirmative decision to purchase the contents of the shopping cart 171, i.e., one or more commercial offerings 134, is processed by step 610. Step 610 is responsible for all tasks associated with the purchase including but not limited to, financial transactions, shipping arrangements, notification emails, and other such operations ancillary to the functioning of the e-commerce application 170. Having completed the purchase of one or more commercial offerings 134, the state of the virtual environment is switched by step 610 to a “navigate/locomote” state in a loop as denoted by the various arrows in the flow diagram shown in FIG. 6.

Finally, in the alternative event user 190 elects to cancel the purchase, one or more commercial offerings 134 can be removed from the virtual shopping cart 171 via cancel step 611. Subsequent the removal of one or more commercial offerings 134 from the shopping cart 171, step 611 having modified the desired configuration of the shopping cart 171, will likewise switch the state of the virtual environment back to a “navigate/locomote” state in a loop as denoted by the various arrows in the flow diagram shown in FIG. 6.

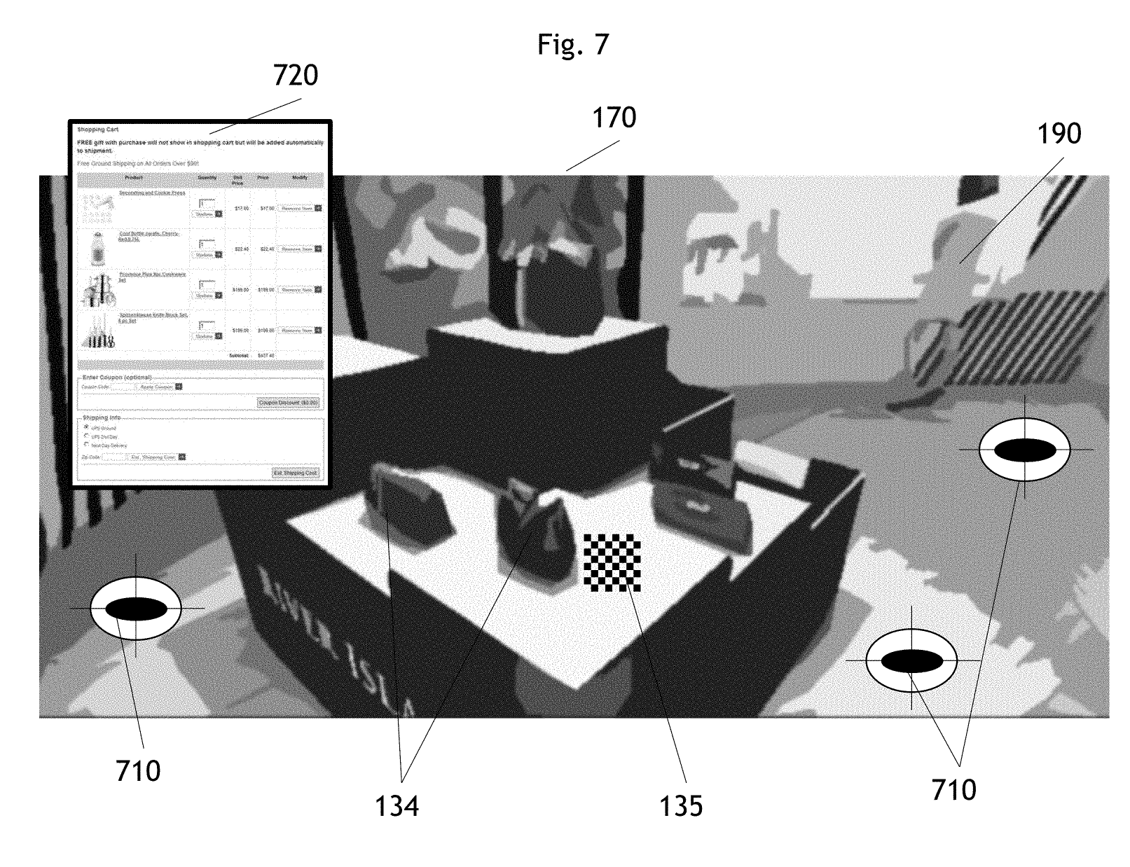

Reference is now made to FIG. 7 an exemplar of a 3D virtual representation of an e-commerce application 170 and virtual shopping cart 171 of the present invention. More particularly the representation is that of a virtual store wherein various commercial offerings 134 are depicted. Additionally, an avatar of another user 190 can be seen in the upper right of the representation. A virtual shopping cart 720 is depicted in the upper left of the representation. User 190 can freely move about the virtual environment as detailed hereinabove in steps 605-606. Likewise, a number of navigational markers/beacons (waypoints) 710 are also shown. It should be noted that waypoints 710 can have fixed locations, i.e., they are bound within the virtual environment and do not change location or position with user 190 navigating from one point to the next. Alternatively, waypoints 710 can be moveable by user 190. A waypoint could, for example, be positioned within the virtual environment using one or more sensors on headgear 130 such as the head position sensor 131. In this scenario, the user 190 could position the waypoint at a desired location within the representation and upon “fixing” it at said desired location, the user 190 could locomote to that position whereupon subsequent navigation within the rendering could be accomplished if desired. As detailed above in steps 607-611 a virtual shopping cart representation 720 is depicted in FIG. 7. The shopping cart shown is an exemplar of its simplest form that being a traditional shopping cart such as would be associated with any typical e-commerce application, e.g. Amazon.com. Many different configurations of shopping cart representation 720 could be implemented within the scope of the present invention including rendering it as a 3D model of a real shopping cart. In any case, regardless of the type or configuration of shopping cart 720, the user 190 will interact with said cart as described in steps 607-611 in order to facilitate the purchase of various commercial offerings 134 which include goods and services, for example.

The above described embodiments are set forth by way of example and are not for the purpose of limiting the scope of the present invention. It will be readily apparent that obvious modifications, derivations and variations can be made to the embodiments without departing from the scope of the invention. For example, the data processing and control program described in detail above as utilizing lock-in amplifier 500 could be one of many other algorithms well known to anyone of ordinary skill in the art. Likewise myriad signal processing techniques are known which could provide output signals substantially equivalent to those utilized by the present invention for example Discrete Fourier Transforms (DFTs), Phase Space Reconstruction, Hidden Markov Models, and Wavelet Analysis. Accordingly, the claims appended hereto should be read in their full scope including any such modifications, derivations and variations.

What is claimed is:

1. An apparatus for controlling a software application utilizing human biopotential signals produced by physiological activity in a user, the apparatus comprising:
a sensor adapted to be applied to a body part of a user for producing an input signal representing an aggregate of human biopotentials, said input signal changing in response to physiological activity of the user;
an amplifier and analog-to-digital converter adapted to digitize said human biopotentials;
a signal processing algorithm responsive to said digitized signal and for generating at least one control signal, said control signal being associated with said physiological activity of the user; and
a software algorithm responsive to said control signal for controlling at least one function of the software application as a function of the changes in said control signal.

2. The brain actuated control apparatus of claim 1 wherein the software application is a three-dimensional (3D) virtual e-commerce application.

3. The brain actuated control apparatus of claim 2 wherein the user can move about within the environment of the virtual e-commerce application.

4. The brain actuated control apparatus of claim 3 wherein the user can preview at least one of a commercial offering.

5. The brain actuated control apparatus of claim 4 wherein the at least one of a commercial offering is graphically rendered in a virtual format.

6. The brain actuated control apparatus of claim 4 wherein the user can select and purchase at least one of a commercial offering.

7. The brain actuated control apparatus of claim 2 wherein the e-commerce application includes the ability to render the user wearing virtual clothing.

8. The brain actuated control apparatus of claim 2 wherein the e-commerce application includes the ability to render the user wearing virtual jewelry.

9. The brain actuated control apparatus of claim 2 wherein the e-commerce application includes the ability to render the user interacting with at least one commercial offering.

10. The brain actuated control apparatus of claim 2 wherein additional users can be visually rendered and interact with any other user of the virtual e-commerce application.

11. The brain actuated control apparatus of claim 5 wherein the at least one of a commercial offering can be manipulated and examined by the user.

12. An apparatus for controlling an e-commerce software application utilizing electromyographic signals produced by muscular activity in a user, the apparatus comprising:
a sensor adapted to be applied to a body part of a user for producing an input signal representing an aggregate of electromyographic biopotentials, said input signal changing in response to muscular activity of the user;
an amplifier and analog-to-digital converter adapted to digitize said electromyographic biopotentials;
a signal processing algorithm responsive to said digitized signal and for generating at least one control signal, said control signal being associated with said muscular activity of the user; and
a software algorithm responsive to said control signal for controlling at least one function of the software application as a function of the changes in said control signal.

13. The brain actuated control apparatus of claim 12 wherein the user can move about within the environment of the virtual e-commerce application.

14. The brain actuated control apparatus of claim 12 wherein the user can preview at least one of a commercial offering.

15. The brain actuated control apparatus of claim 14 wherein the at least one of a commercial offering is graphically rendered in a virtual format.

16. The brain actuated control apparatus of claim 14 wherein the user can select and purchase at least one commercial offering.
